(19) United States
(12) Patent Application Publication
(10) Pub. No.: US 2004/0135678 A1
(43) Pub. Date: Jul. 15, 2004

(54) Radio receiver integrated vehicular meter unit

(76) Inventors: Yuji Sugimoto, Okazaki-city (JP); Syuichi Kono, Okazaki-city (JP); Tomoyuki Miyagawa, Nukata-gun (JP); Haruyuki Ikeo, Chiryu-city (JP)

Correspondence Address: POSZ & BETHARDS, PLC, 11250 ROGER BACON DRIVE, SUITE 10, RESTON, VA, 20190, US

(21) Appl. No.: 10/696,568

(22) Filed: Oct. 30, 2003

(30) Foreign Application Priority Data
Nov. 1, 2002 (JP) 2002-319283
Jul. 24, 2003 (JP) 2003-279031

(51) Int. Cl. B60Q 1/00

(52) U.S. Cl. 340/425.5; 361/600

(57) ABSTRACT

In a radio receiver integrated vehicular meter unit, a receiver circuit of the radio receiver is arranged on the side of a meter circuit board opposite to the side on which a CPU and a communication IC included in a meter circuit are mounted. The distance between the receiver circuit board and the CPU or the communication IC increases by the thickness of the meter circuit board. As a result, a receiver circuit formed on the receiver circuit board is less affected by noise caused by the CPU or the communication IC.

### CROSS REFERENCE TO RELATED APPLICATION

This application is based on and incorporates herein by reference Japanese Patent Applications No. 2002-319283 filed on Nov. 1, 2002 and No. 2003-279031 filed on Jul. 24, 2003.

### FIELD OF THE INVENTION

The present invention relates to a radio receiver integrated vehicular meter unit.

### BACKGROUND OF THE INVENTION

Radio receivers other than a radio in an audio system are installed on a vehicle. An example of such radio receivers is a radio receiver used in a vehicular keyless entry system. The keyless entry system controls locks of vehicle doors and a start of an engine. The system includes a keyless entry receiver installed on the vehicle and a keyless entry transmitter embedded in a key.

When signals indicative of an identification (ID) code and an operation code are inputted from the transmitter to the receiver, it demodulates the signals. It is determined whether the signal has been sent from a proper transmitter, that is, the transmitter pair with the receiver, based on the ID code. If it determined that the signal has been sent from the proper transmitter, a control signal corresponding to the operation code is transmitted to electronic control units (ECUs). Then, the ECUs perform respective controls, such as locking or unlocking the doors and starting the engine. The radio signal used in the system is usually a weak signal ranging around 300 MHz.

To provide reliable operations of the keyless entry system, the receiver is required to have a certain sensitivity for accurately demodulating the signal into the ID code or the operation code. A meter unit having a radio receiver is proposed in JP-A-8-216735. In this meter unit, a meter circuit for displaying vehicle condition information the vehicle speed in response to changes in actual vehicle speeds is formed on a substrate and housed in a meter housing. A part of the substrate is reserved for a receiver circuit. Because the receiver is located adjacent to a window, radio signals are less likely to be blocked by a metal body of the vehicle.

The meter circuit includes a processing unit, such as a CPU. The processing unit outputs control signals for displaying the driving information and communication signals for communicating with an external device in a communication network. The processing unit produces a high-frequency clock signal as a reference signal that causes noise in a frequency range used in the system. When the receiver is integrated into the meter unit, the noise interferes with the meter circuit that may cause malfunction of the system. The meter circuit performs a shutdown operation including initialization of display conditions for a certain period after an ignition is turned off. If the malfunction occurs when a driver is away from the vehicle, it will be a problem from a safety stand point.

### SUMMARY OF THE INVENTION

The present invention therefore has an objective to provide a radio receiver integrated meter unit for a vehicle that is less affected by noise. A meter unit of the present invention includes a display, a meter circuit, and a radio receiver. The display that faces a driver includes meters for indicating driving information. The meter circuit formed on a meter circuit board and housed in a meter housing controls the meters for indicating the driving information in response to changes in actual driving conditions of the vehicle. The radio receiver includes a receiver circuit and an antenna. The receiver is arranged on a side of the meter circuit board opposite to a side on which a high-frequency signal source component that generates a high-frequency signal is mounted.

With this configuration, a distance between the receiver circuit and the high-frequency signal source component can be increased by the thickness of the meter circuit board. As a result, the noise caused by the high-frequency signal component is less likely to interfere with the receiver and therefore the receiver is less likely to output improper demodulated signals.

### BRIEF DESCRIPTION OF THE DRAWINGS

The above and other objectives, features and advantages of the present invention will become more apparent from the following detailed description made with reference to the accompanying drawings. In the drawings:

FIG. 1 a perspective view of a meter unit according to the first embodiment of the present invention;

FIG. 2A is a cross-sectional view of the meter unit according to the first embodiment;

FIG. 2B is a cross-sectional view of the meter unit having another circuit board according to the first embodiment.

FIG. 3 is a front view of a meter circuit board included in the meter unit showing arrangements of electronic components according to the first embodiment;

FIG. 4 is a rear view of the meter circuit board according to the first embodiment;

FIG. 5 is a block diagram showing operations of a CPU included in the meter circuit according to the first embodiment;

FIG. 6 is a graph showing a relationship between a noise level around a receiver unit included in the meter unit and a distance between a receiver circuit board of the receiver and the meter circuit board according to the first embodiment;

FIG. 7 is an explanatory view of the meter unit for explaining how to measure the noise level shown in FIG. 6 according to the first embodiment;

FIG. 8A is a schematic diagram showing an arrangement and a condition of measurement in which the intensity of the magnetic field around the first surface of the meter circuit board according to the first embodiment;

FIG. 8B is a schematic diagram showing an arrangement and a condition of measurement in which the intensity of the magnetic field around the second surfaces of the meter circuit board according to the first embodiment;

FIG. 9A is a distribution graph showing intensity of the magnetic field measured under the condition shown in FIG. 8A;

FIG. 9B is a graph showing intensity of the magnetic field measured under the condition shown in FIG. 8B; and

FIG. 10 is a cross-sectional view of a meter unit according to the second embodiment of the present invention.

### DETAILED DESCRIPTION OF THE PREFERRED EMBODIMENT

The preferred embodiments of the present invention will be explained with reference to the accompanying drawings. In the drawings, the same numerals are used for the same components and devices.

[First Embodiment]

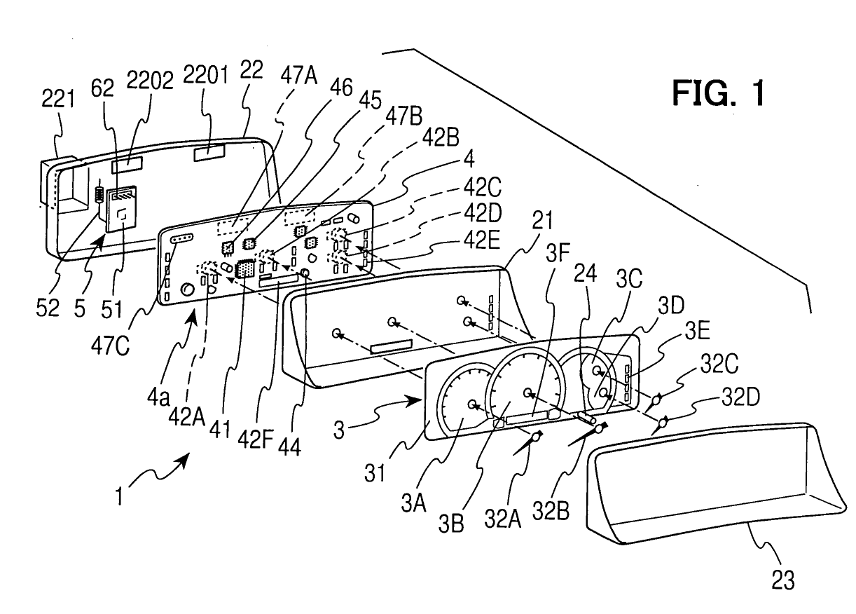

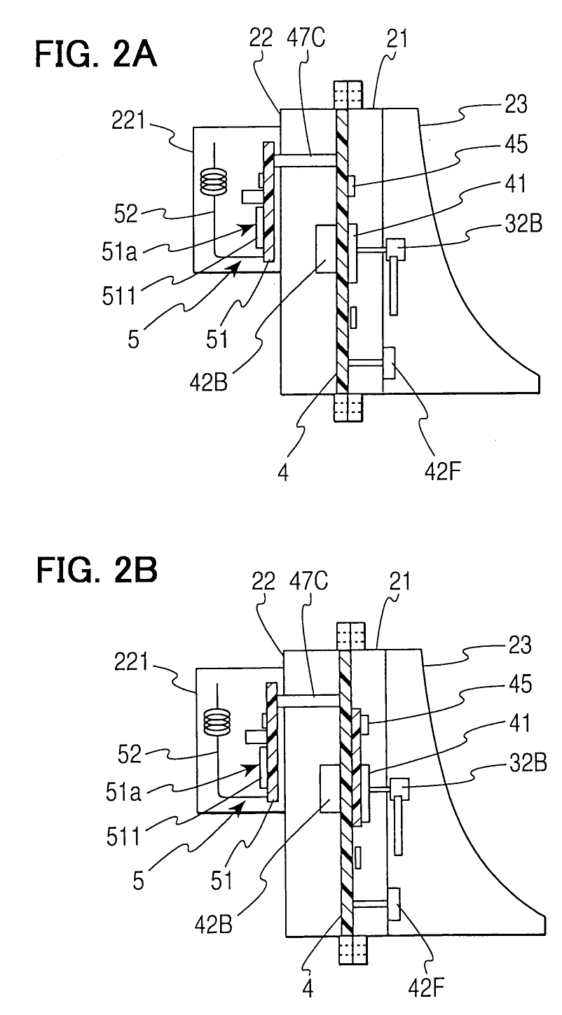

Referring to FIGS. 1 and 2, a meter unit 1 includes an upper housing 21, a lower housing 22, a clear housing 23, a display 3, a meter circuit board 4, and a keyless entry receiver 5. The upper hosing 21 and the lower hosing 22 are fitted in an instrument panel of a vehicle. The display 3 is housed by the upper housing 21 and covered with the clear housing 23. The display 3 including meters 3A, 3B, 3C, and 3D arranged on a display plate 31 provides driving information to a driver. The meter circuit board 4 and the receiver 5 are arranged at the rear of the display plate 31. A meter circuit board 51 of the receiver 5 is connected to a corner of the meter circuit board 4.

A speedometer 3B is arranged substantially in the center of the display plate 31. A tachometer 3A is arranged on the left of the speedometer 3B. An oil temperature gauge 3C and a fuel gauge 3D are arranged on the right of the speedometer 3B. Pointers 32A, 32B, 32C, and 32D are provided for the tachometer 3A, a speedometer 3B, the oil temperature gauge 3C, and the fuel gauge 3D, respectively.

The pointers 32A, 32B, 32C, and 32D are fixed to ends of shafts of display motors (cross coils) 42A, 42B, 42C, and 42D, and point scales on the meters 32A, 32B, 32C, and 32D as the display motors 42A, 42B, 42C, and 42D rotate. A liquid crystal display (LCD)-type trip meter 3F is arranged below the speedometer 3B. A LCD switching button 24 is provided for resetting a reading of the trip meter 3F. The tip of the LCD switching button 24 penetrates through the clear housing 23 so that it projects toward the driver. The lower housing 22 has a projecting part 221 that projects outwardly for housing the receiver 5.

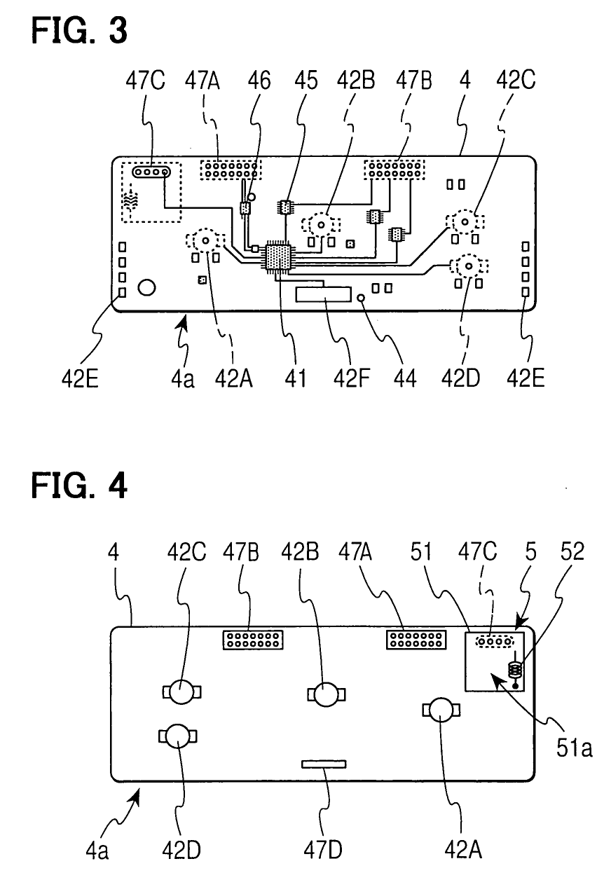

The meter circuit board 4 made of an insulating material, such as a glass epoxy resin, includes a meter circuit 4a constructed of various components as shown in FIGS. 3 and 4. The meter circuit 4a includes a CPU 41, the display motors 42A-42D, LEDs 42E, an LCD 42F, and a reset switch 44. The LEDs 42F form an indicator lamp 3E and the LCD 42F is a part of the trip meter 3F. The reset switch 44 is activated when the LCD switching button 24 is pressed. The meter circuit 4a also contains a communication IC 45 connected between the CPU 41 and the external communication network. The CPU 41 is connected to the communication network via the communication IC 45 for data communication. A multiplex communication system is used for the communication network. A control signal corresponding to an operation code demodulated by the receiver 5 is transmitted to a microcomputer in a control electronic control unit (ECU) via the network.

The meter circuit board 4 further includes a power supply regulator 46, a power supply connector 47A, a communication connector 47B, and a receiver connector 47C. The power supply regulator 46 is provided for supplying power to the circuit components. The connectors 47A, 47B, and 47C are provided for connecting the meter circuit 4a and a receiver circuit 51a with a power supply, the communication IC 45 with the network, and the receiver 5 with the CPU 41, respectively. The CPU 41 receives driving information including a speed, a fuel level, an engine rotation speed, and an oil temperature, and outputs control signals to the display motors 42A-42D and the LCD 42F based on the information.

The CPU 41 and the communication IC 45 are mounted on the meter circuit board 4. They process inputted signal and output the processed signal based on clock signals. The clock signals are generated by a crystal oscillator at a frequency of about 4 MHz. The meter circuit 4a operates for a certain period after the ignition is turned off for restore operations in a default condition in addition to the clock signal generation. The CPU 41 and the communication IC 45 can be mounted on another circuit board smaller than the meter circuit board 4 and mounted on the meter circuit board 4 as shown in FIG. 2B.

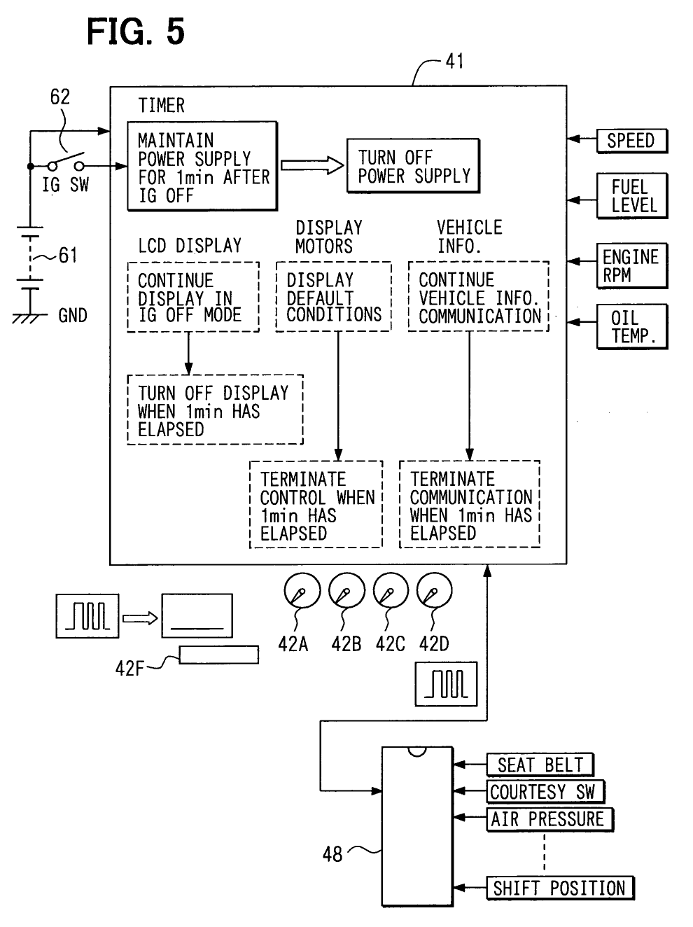

Referring to FIG. 5, the CPU 41 outputs control signals to the display motors 42A-42D and the LCD 42F for displaying necessary information. The CPU 41 intercommunicates with a vehicle condition signal processing IC 48. The signal processing IC 48 starts operating when it receives a clock signal from the CPU 41 and outputs detected conditions of various parts of the vehicle, such as a seat belt, a courtesy switch, an air pressure, and a shift position, to the CPU 41. The signal processing IC 48 is mounted on the same surface of the meter circuit board 4 as the CPU 41 is mounted.

The CPU 41 receives signals indicative of the speed, the fuel level, the engine rotation speed, and the oil temperature from a speed sensor, a fuel sensor, an engine speed sensor, and an oil temperature sensor. An output of the battery 61 is inputted to the CPU 41 via the ignition switch 62. When the ignition switch 62 is turned off, the CPU 41 detects the off condition of the ignition by a voltage change at the ignition switch 62. Then, the CPU 41 switches an operation mode to an ignition off mode.

Referring to FIG. 5, in the ignition-off mode, a timer is activated for maintaining the power supply for one minute after the ignition switch 62 is turned off. When the timer exceeds one minute, the power supply is turned off. The display motors 42A-42D are controlled so that default conditions are displayed for one minute after the ignition switch 62 is turned off. The control terminates when one minute has elapsed. The LCD 42F is controlled so that it does not output new data after the ignition switch 62 is turned off and the display is turned off when one minute has elapsed. The vehicle information communication with the signal processing IC 48 continues until one minute has elapsed. The CPU 41 continues communication with the signal processing IC 48 until one minute has elapsed after the ignition switch 62 is turned off.

Electronic components that may output high-frequency signals, such as clock signals, are not mounted on the surface of the meter circuit board 4 which the receiver 5 is mounted only ones that do not output high-frequency signals including the display motors 42A-42D are mounted on the surface. The receiver 5 has the receiver circuit 51 to which an antenna 52 is connected. The antenna 52 receives radio signals from a keyless entry transmitter (not shown). The receiver 5 and the transmitter form a radio-type keyless entry system. A radio signal at the frequency of about 300 MHz is used in the keyless entry system.

The antenna 52 is integrated in the receiver circuit board 51. A receiver circuit 51a constructed of various components is formed on the receiver circuit board 51. When the receiver 5 has detected a radio signal from the transmitter, it demodulates the signal. Then, it determines whether an ID code indicated by the signal match the ID code of the paired transmitter based on the demodulated signal. If the result of the determination is yes, it outputs a control signal corresponding to an operation code to control ECUs via the connectors 47B and 47C for unlocking or locking the doors or starting the engine.

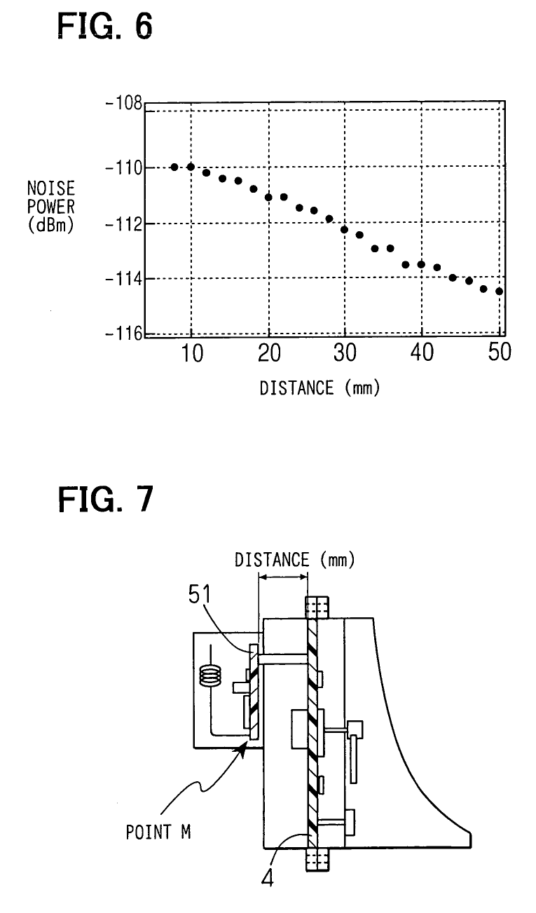

If noise is caused by high-frequency signals, the receiver 5 may output an improper demodulated signal. A level of the noise varies depending on a distance between the meter circuit board 4 and the receiver circuit board 51 as shown in FIG. 6. The noise level is measured at a point M between a power supplying point of the receiver circuit board 51 and a ground as shown in FIG. 7. The noise level decreases as the distance increases. In other words, a certain distance is required between the meter circuit board 4 and the receiver circuit board 51. However, it is difficult to reserve much space in the meter unit 1 because reinforcements assembled at the rear of the meter unit 1 take us space in the instrumental panel.

Therefore, the CPU 41 and the communication IC 45 are mounted on the side of the meter circuit board 4 away from the receiver 5. In this case, an additional distance is provided between the CPU 41 or the IC 45 and the receiver circuit 51a by the thickness of the meter circuit board 4. Since the noise level decreases inversely proportional to the second or the third power of the distance between a noise source and the receiver circuit board 51, even small changes in distance makes a big differences in noise level. The noise level can be greatly reduced with respect to the noise level when the noise source is mounted on the opposite side of the meter circuit board 4 adjacent to the receiver 5. Thus, the receiver 5 is less likely to output an improper demodulated signal.

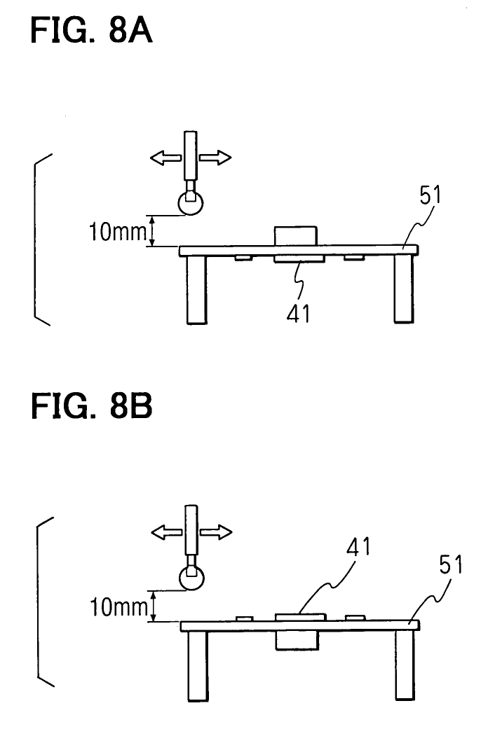

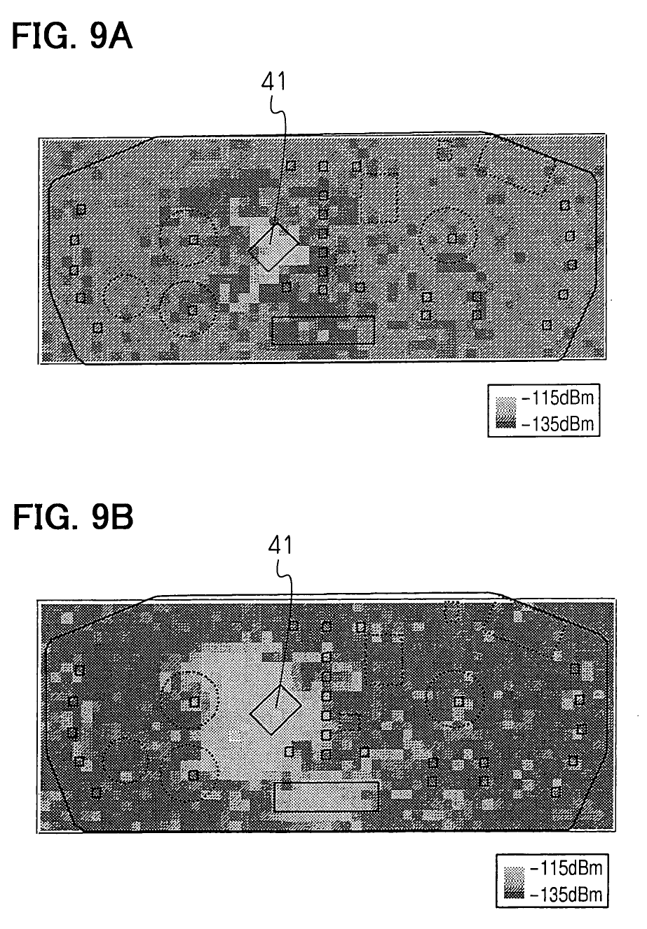

Intensity of the magnetic field around the first surface of the meter circuit board 4 to which the receiver 5 faces is measured as shown in FIG. 8A. In the measurement, the surface is scanned by a magnetic field scan probe positioned about 10 mm away from the surface. The scan probe has a loop antenna at its tip and outputs changes in flux passing through the loop antenna. The magnetic field distribution obtained from the measurement is shown in FIG. 9A expressed in gray scales. The color of the gray scale becomes lighter as the intensity of the magnetic field becomes higher. Intensity of the magnetic field around the second surface the meter circuit board 4, which is an opposite surface to the first surface, is measured as shown in FIG. 8B in the same manner as the first surface. The results are shown in FIG. 9B.

The results of the above measurements show that the intensity of the magnetic field around the first surface is lower than the second surface. In other words, the receiver 5 is less likely to be affected by the noise when it faces the surface on which the CPU 41 and the IC 45 are not mounted. Therefore, malfunctions of the receiver 5 resulted from the noise can be reduced.

[Second Embodiment]

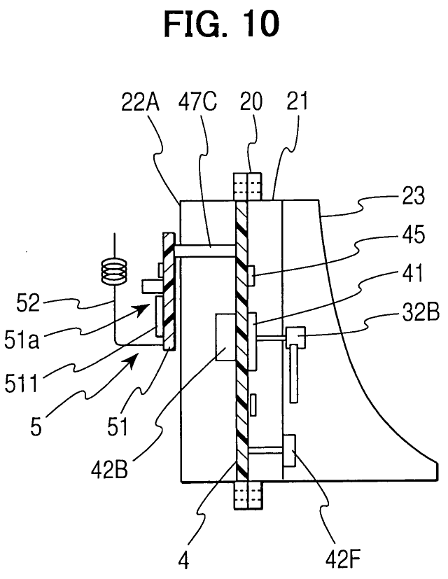

Referring to FIG. 10, the meter unit includes a lower housing 22A that does not have the projecting part 221 shown in FIG. 2A. The receiver circuit board 51 is arranged in parallel with the meter circuit board 4 outside the lower housing 22A. The receiver circuit board 51 and the meter circuit board 4 are electrically and physically connected by the connector 47C that penetrates through the lower housing 22A.

Even if the keyless entry system is provided as an option and the receiver 5 is connected to the meter circuit board 4 afterwards, the lower housing 22A can be used without modification. The receiver circuit 51 is less likely to be affected by the noise caused by the high-frequency signal source because the receiver 5 is arranged away from the signal source.

The present invention should not be limited to the embodiment previously discussed and shown in the figures, but may be implemented in various ways without departing from the spirit of the invention. For example, the receiver circuit board 51 may be connected to the right side of the meter circuit board 4 as long as the CPU 41 and the IC 45 are mounted on the other side of the meter circuit board from the receiver circuit board 51.

Either CPU 41 or IC 45 may be mounted on the same side as the receiver 5 depending on the noise reduction requirement. When adding high-frequency signal generating circuits other than the CPU 41 and the IC 45, the circuits may be mounted on the side away from the receiver 5 for reducing malfunctions of the keyless entry system. Components and wiring patterns of the circuit should be arranged on a side of the smaller circuit board away from the meter circuit board 4.

The meter circuit 51a may be formed on the meter circuit board 4 along with the meter circuit. In this case, the meter circuit 51a and the meter circuit are formed opposite sides of the meter circuit board 4. The meter circuit may include a circuit that stops its function immediately after the ignition switch 62 is turned off. The meter circuit board 5 may include a circuit for performing function other than the meter display.

What is claimed is:

1. A vehicular meter unit having an integrated radio receiver comprising:
a display, which faces a driver of the vehicle, including a meter for indicating driving information of a vehicle;
a meter circuit for controlling the meter for indicating the driving information in response to changes in actual driving condition of the vehicle;
a meter circuit board on which the meter circuit is formed housed by a meter housing; and
a radio receiver including a receiver circuit and an antenna for receiving a radio signal, wherein the radio receiver is arranged on a side of the meter circuit board opposite to a side on which a high-frequency signal source component that generates a high frequency signal is mounted.

2. The vehicular meter unit according to claim 1, wherein:
the meter circuit includes a processing unit that outputs a control signal for indicating the driving information on the display; and
the processing unit is the high-frequency signal source component.

3. The vehicular according to claim 1, wherein:
the meter circuit includes a communication unit for intercommunicating with an external communication network; and
the communication unit is the high-frequency signal source component.

4. The vehicular meter unit according to claim 1, wherein the high-frequency signal source component is mounted on a circuit board smaller than the meter circuit board and arranged over the meter circuit board.

5. The vehicular meter unit according to claim 1, wherein the meter circuit operates for a predetermined period after an ignition is turned off.

6. The vehicular meter unit according to claim 1, wherein the receiver circuit and the antenna are housed in the meter housing.

7. The vehicular meter unit according to claim 2, wherein:
the meter circuit further includes a communication unit for intercommunicating with an external communication network;
the communication unit is another high-frequency signal source component; and
the communication unit is connected between the processing unit and the external communication network.
